(19) United States
(12) Patent Application Publication
(10) Pub. No.: US 2025/0131901 A1
(43) Pub. Date: Apr. 24, 2025

(54) PERCUSSION INSTRUMENT AND METHOD FOR REDUCING VOLUME OF PERCUSSION INSTRUMENT

(71) Applicant: Roland Corporation, Shizuoka (JP)

(72) Inventors: Kiyoshi YOSHINO, Hamamatsu, Shizuoka (JP); Masato KATSUDA, Hamamatsu, Shizuoka (JP)

(73) Assignee: Roland Corporation, Shizuoka (JP)

(21) Appl. No.: 18/689,845

(22) PCT Filed: Dec. 28, 2021
(86) PCT No.: PCT/JP2021/048876

§ 371 Date: Mar. 6, 2024

(51) Int. Cl. G10D 13/14; G10D 13/02; G10D 13/20; G10H 3/14; H04R 1/40; H04R 3/00; H04R 3/04

(52) U.S. Cl. CPC G10D 13/14; G10D 13/02; G10D 13/20; G10H 3/146; H04R 1/406; H04R 3/005; H04R 3/04

(57) ABSTRACT

A percussion instrument includes: a body of a cylindrical shape; a striking head, attached to one axial side of the body; a resonance head, attached to the other axial side of the body; and a sound absorbing material, formed in a disk shape that provides a partition between the striking head and the resonance head, and having an outer edge joined to an inner peripheral surface of the body.

### TECHNICAL FIELD

The present invention relates to a percussion instrument and a method for reducing volume of a percussion instrument, and in particular, to a percussion instrument capable of reproducing a timbre of acoustic drums while the volume of the percussion instrument is reduced, and a method for reducing volume of a percussion instrument.

### RELATED ART

In the second half of the 20th century, acoustic drums were improved with the aim of increasing the volume thereof. During that period, improvements in acoustic technology using microphones or speakers had gradually made the above-mentioned high volume performance unnecessary. Conversely, emphasis has been placed on solving problems such as the possibility of damage caused by the high volume to the ear, the need to consider the volume balance with other instruments in an ensemble, and the occurrence of restrictions on performance location or time. Hence, there has been a demand for a percussion instrument that has reduced volume and possesses expressiveness (drum-like sound). The realization of such a percussion instrument that has reduced volume and possesses expressiveness solves the above problems associated with acoustic drums and develops the music industry.

As a technology of reducing the volume when a drumhead is struck, for example, Patent Document 1 describes a technology in which a sound absorbing material 70 is attached to a first closure plate 60-1 arranged below a net 11 (head). According to this technology, since sound (vibration) propagated downward from the net 11 is absorbed by the sound absorbing material 70, the volume of the percussion instrument can be reduced.

### PRIOR-ART DOCUMENTS

### Patent Documents

Patent Document 1: Japanese Patent Laid-Open No. 2008-026350 (for example, paragraph 0023 and FIG. 1)

### SUMMARY OF THE INVENTION

### Problems to be Solved by the Invention

However, in the conventional technology described above, since the sound (vibration) propagated from the net 11 (head) is blocked by the first closure plate 60-1 or the sound absorbing material 70, other members located below the closure plate or the sound absorbing material are less likely to vibrate (resonate). Thus, there is a problem that a timbre of acoustic drums cannot be reproduced.

The present invention has been made to solve the problems described above, and an object thereof is to provide a percussion instrument and a method for reducing volume of a percussion instrument, in which a timbre of acoustic drums can be reproduced while the volume of the percussion instrument is reduced.

### Means for Solving the Problems

To achieve this object, a percussion instrument of the present invention includes: a body of a cylindrical shape; a striking head, attached to one axial side of the body; a resonance head, attached to the other axial side of the body; and a sound absorbing material, formed in a disk shape that provides a partition between the striking head and the resonance head, and having an outer edge joined to an inner peripheral surface of the body.

A percussion instrument of the present invention includes: a body of a cylindrical shape; a striking head, attached to one axial side of the body; a resonance head, attached to the other axial side of the body; and a sound absorbing material of a cylindrical shape, having an outer peripheral surface joined to an inner peripheral surface of the body.

A method for reducing volume of a percussion instrument of the present invention is a method for reducing the volume of the following percussion instrument. The percussion instrument includes: a body of a cylindrical shape; a striking head, attached to one axial side of the body; a resonance head, attached to the other axial side of the body; and a sound absorbing material, formed in a disk shape that provides a partition between the striking head and the resonance head, and having an outer edge joined to an inner peripheral surface of the body. In the method, sound generated when the striking head is struck is absorbed by the sound absorbing material.

A method for reducing volume of a percussion instrument of the present invention is a method for reducing the volume of the following percussion instrument. The percussion instrument includes: a body of a cylindrical shape; a striking head, attached to one axial side of the body; a resonance head, attached to the other axial side of the body; and a sound absorbing material of a cylindrical shape, having an outer peripheral surface joined to an inner peripheral surface of the body. In the method, sound generated when the striking head is struck is absorbed by the sound absorbing material.

### BRIEF DESCRIPTION OF THE DRAWINGS

FIG. 1 is a cross-sectional view of a percussion instrument according to a first embodiment.

FIG. 2 is a block diagram showing an electrical configuration of the percussion instrument.

FIG. 3 is a cross-sectional view of a percussion instrument according to a second embodiment.

FIG. 4 is a cross-sectional view of a percussion instrument according to a third embodiment.

### DESCRIPTION OF THE EMBODIMENTS

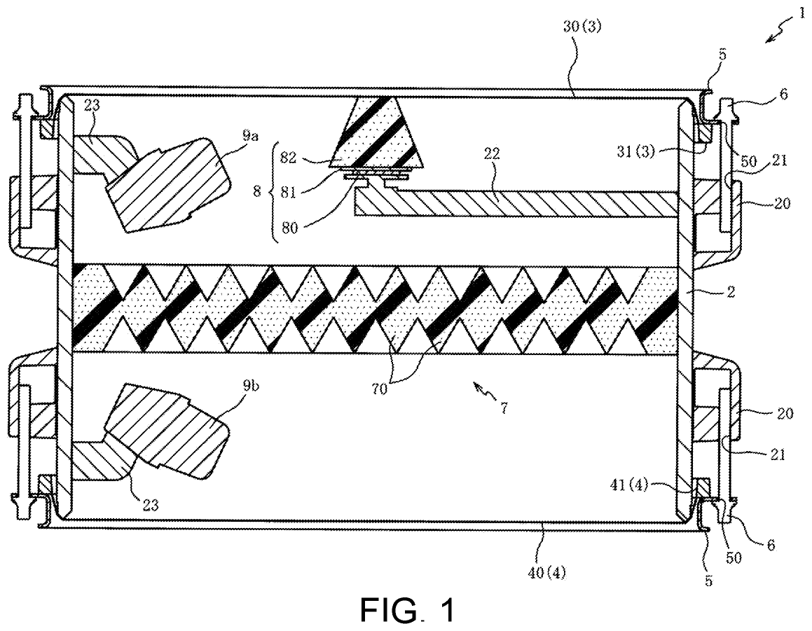

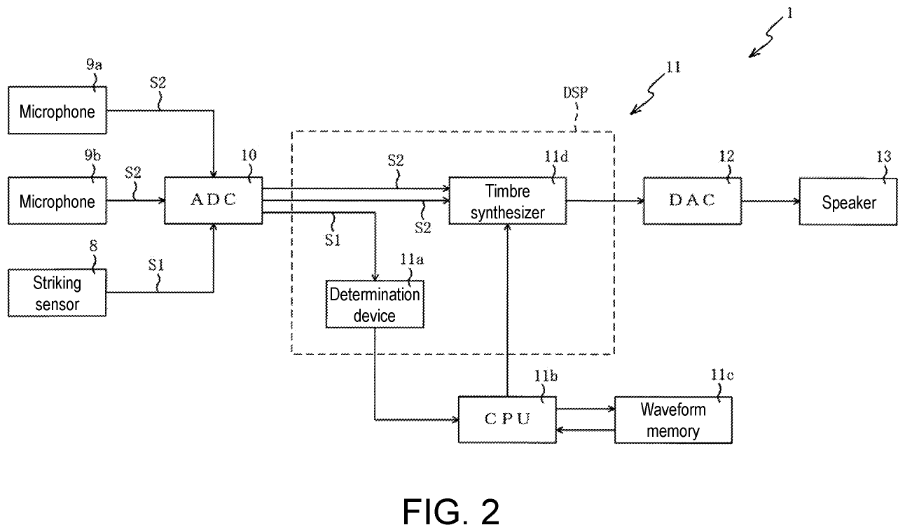

Hereinafter, preferred embodiments will be described with reference to the accompanying drawings. First, a configuration of a percussion instrument 1 of the first embodiment is described with reference to FIG. 1 and FIG. 2. FIG. 1 is a cross-sectional view of the percussion instrument 1 according to the first embodiment. FIG. 2 is a block diagram showing an electrical configuration of the percussion instrument 1.

As shown in FIG. 1, the percussion instrument 1 is a percussion instrument (electronic drum) in which both ends in an up-down direction (axial direction) of a body 2 of a cylindrical shape are covered with a striking head 3 and a resonance head 4. The striking head 3 covering an upper surface side of the body 2 includes a membrane 30 of a disk shape to be struck by a performer. A frame 31 of an annular shape is connected (fixed) to an outer edge of the membrane 30.

The frame 31 is formed using a resin material, and the membrane 30 and the frame 31 are integrally molded by die molding. The frame 31 may be formed using a material (for example, metal or wood) other than resin, and the frame 31 may be configured to be joined to the membrane 30 by adhesion or the like. The frame 31 is fixed to the body 2 by a hoop 5 of an annular shape.

In the hoop 5, through holes 50 into which bolts 6 are inserted are formed at equal intervals in a circumferential direction. In the body 2, fastening parts 20 for screwing the bolts 6 therein are formed at equal intervals in the circumferential direction. A female threaded hole 21 is formed in the fastening part 20. The female threaded hole 21 is formed in a position corresponding to the through hole 50 of the hoop 5. With the hoop 5 hooked to the frame 31 arranged on an outer peripheral side of the body 2, by screwing the bolt 6 passed through the through hole 50 of the hoop 5 into the female threaded hole 21, tension is applied to the membrane 30 of the striking head 3. Accordingly, a state is achieved which allows the performer to strike the striking head 3 (membrane 30).

The resonance head 4 includes a membrane 40 and a frame 41 having the same configurations as the membrane 30 and the frame 31 of the striking head 3, and the resonance head 4 is fixed to a lower surface side of the body 2 by the same fixing method (using the hoop 5) as the striking head 3. A sound absorbing material 7 for absorbing sound generated when the striking head 3 is struck is provided between the striking head 3 and the resonance head 4. The sound absorbing material 7 is formed in a disk shape using urethane foam (foamed resin). A protrusion 70 of a quadrangular pyramid shape is formed on the sound absorbing material 7. The protrusions 70 are arranged side by side without a gap therebetween on both upper and lower surfaces of the sound absorbing material 7.

The sound absorbing material 7 is joined (bonded) at an outer edge thereof to an inner peripheral surface of the body 2 in a state of providing a partition between the striking head 3 and the resonance head 4. Accordingly, vibration propagated downward when the striking head 3 is struck enters the sound absorbing material 7 that is porous, and the vibration is dampened. At this time, since the sound absorbing material 7 is brought into a state of being swingable to the body 2, that is, a state in which the sound absorbing material 7 is able to freely vibrate and has no member that hinders the vibration of the sound absorbing material 7 except for a portion in contact with the body 2, the vibration propagated from the striking head 3 causes the sound absorbing material 7 to moderately vibrate as well.

Since moderate vibration is transmitted to the membrane 40 of the resonance head 4 as well due to the vibration of the sound absorbing material 7, the resonance head 4 is enabled to resonate. In this way, by absorbing the sound generated when the striking head 3 is struck by the sound absorbing material 7 and causing the resonance head 4 to resonate, a timbre of acoustic drums can be reproduced while the volume of the percussion instrument 1 is reduced.

A thickness of the sound absorbing material 7 in the axial direction (up-down direction in FIG. 1) of the body 2 is one-third or less of an axial dimension of the body 2. The sound absorbing material 7 is arranged in an area including an axial center of the body 2. Accordingly, a distance between the striking head 3 and the sound absorbing material 7 or a distance between the resonance head 4 and the sound absorbing material 7 is greater than the thickness of the sound absorbing material 7. By adjusting such a thickness of the sound absorbing material 7 or the distance between the sound absorbing material 7 and the striking head 3 (resonance head 4), a degree of volume reduction of the sound generated when the striking head 3 is struck or a degree of volume reduction of a resonance sound of the resonance head 4 can be adjusted.

Accordingly, for example, if the sound absorbing material 7 is arranged closer to the resonance head 4 side than the axial center of the body 2, an effect of increasing the degree of volume reduction of the resonance sound of the resonance head 4 can be achieved while the degree of volume reduction of the sound generated when the striking head 3 is struck is decreased. On the other hand, if the sound absorbing material 7 is arranged closer to the striking head 3 side than the axial center of the body 2, an effect opposite to that described above can be achieved.

Here, in a conventional percussion instrument that simulates an acoustic drum, a membrane may be formed of a reticulated material (mesh) in order to reduce the volume of sound generated when a striking head is struck. Examples of such a reticulated material include a polyester mesh having a mesh number (number of threads about per inch) of 90 to 150 and an aperture ratio of 10% to 30% (for example, Japanese Patent Laid-Open No. 2008-026350).

On the other hand, the striking head 3 of the present embodiment is a fabric obtained by plain weaving or twill weaving multifilaments, and has a low aperture ratio (of, for example, less than 5%) compared to the above-mentioned conventional mesh. Compared to a striking surface of an acoustic drum using a synthetic resin film, the striking head 3 made of a fabric configured in this way has lower volume when struck. Moreover, compared to a conventional striking surface made of a mesh, the striking head 3 is capable of reproducing the timbre of acoustic drums.

Similarly, since the resonance head 4 is a fabric obtained by plain weaving or twill weaving multifilaments, while the resonance head 4 is caused to resonate with the vibration of the striking head 3, the volume of the resonance sound of the resonance head 4 can be reduced. Accordingly, the timbre of acoustic drums can be reproduced while the volume of the percussion instrument 1 is reduced.

A material of the multifilament is not particularly limited, and examples thereof include polyester and nylon.

A support 22 that supports a striking sensor 8 extends radially inward from the inner peripheral surface of the body 2. The striking sensor 8 is fixed to a tip portion of the support 22. The striking sensor 8 includes a double-sided tape 80 of a disk shape that is bonded to the support 22. The double-sided tape 80 has cushioning properties. A sensor 81 which is a disk-shaped piezoelectric element is bonded to an upper surface of the double-sided tape 80. A cushion 82 of a truncated cone shape is bonded to an upper surface of the sensor 81. The cushion 82 is formed using a sponge.

Since the cushion 82 comes into contact with a lower surface of the striking head 3, vibration generated when the membrane 30 of the striking head 3 is struck is transmitted to the sensor 81 via the cushion 82. Although described later in detail, a detection result of striking obtained by the sensor 81 (striking sensor 8) is output to a signal processing part 11 (see FIG. 2). A musical tone signal is generated by the signal processing part 11 based on the detection result of the sensor 81, and an electronic sound is emitted from a speaker 13 based on the musical tone signal.

In an initial state before the striking head 3 is struck, the cushion 82 of the striking sensor 8 comes into contact with the center of the striking head 3. Accordingly, since the vibration generated when the striking head 3 is struck is likely to be damped by the cushion 82, the volume of the percussion instrument 1 can be reduced. This allows the striking sensor 8 to have a function of reducing the volume of the percussion instrument 1 in addition to the function of detecting striking on the striking head 3.

Furthermore, since the cushion 82 itself, which is formed using foamed resin, has the same sound absorption function as the sound absorbing material 7, the volume of the percussion instrument 1 can be reduced by the cushion 82.

Although not illustrated, the support 22 that supports the striking sensor 8 is formed in a rod shape (elongated), and the striking sensor 8 is supported in a cantilevered manner by the rod-shaped support 22. Accordingly, compared to, for example, a configuration in which the support 22 is formed in a plate shape or a configuration in which the support 22 is bridged between the inner peripheral surfaces of the body 2, a space for arranging the support 22 can be reduced (the support 22 can be reduced in size). Thus, since the support 22 can be prevented from interfering with the vibration (sound) propagated downward from the striking head 3, the timbre of acoustic drums can be reproduced.

A support 23 that supports a microphone 9a and a microphone 9b extends radially inward from the inner peripheral surface of the body 2. The microphones 9a and 9b are supported at a tip of the support 23. The microphone 9a is directed toward the striking head 3, and the microphone 9b is directed toward the resonance head 4. The microphones 9a and 9b are microphones that convert the sound of the percussion instrument 1 resulting from the sound generated when the striking head 3 is struck or the resonance sound of the resonance head 4 into an electrical signal, and the sound of the percussion instrument 1 collected by the microphones 9a and 9b is processed by the signal processing part 11 (see FIG. 2).

As shown in FIG. 2, the percussion instrument 1 includes an analog-to-digital converter (ADC) 10 that converts a striking signal S1 output from the striking sensor 8 and a microphone signal S2 output from the microphones 9a and 9b from analog signals to digital signals.

The striking signal S1 of the striking sensor 8 converted into a digital signal by the ADC 10 is input to a determination device 11a of a DSP constituting the signal processing part 11. The determination device 11a determines, from the input striking signal S1, start (presence or absence) of striking, a struck position, strength of striking and so on (which are hereinafter referred to as “striking information”), and outputs the striking information to a CPU 11b.

The CPU 11b reads waveform data (PCM waveform) corresponding to the input striking information from a waveform memory 11c. The waveform data is data obtained by converting waveform information of a pre-collected musical tone or the like into a digital signal. The waveform data read from the waveform memory 11c by the CPU 11b is input to a timbre synthesizer 11d of the DSP.

The microphone signal S2 that has been converted into a digital signal by the ADC 10 is input to the timbre synthesizer 11d. The timbre synthesizer 11d outputs to a DAC 12 a musical tone signal in which the microphone signal S2 and the waveform data read by the CPU 11b are mixed together. The DAC 12 converts the input musical tone signal from a digital signal to an analog signal and outputs the same to the speaker 13. The speaker 13 emits a musical tone based on the input musical tone signal. Accordingly, a musical tone obtained by synthesizing the electronic sound based on the detection result (striking information) of vibration obtained by the striking sensor 8 and a microphone sound collected by the microphones 9a and 9b can be emitted from the speaker 13.

The volume of the percussion instrument 1 is reduced by the sound absorbing material 7 as described above. In the sound of the percussion instrument 1 whose volume is reduced by the sound absorbing material 7, high frequency components (of, for example, 1 kHz or higher) are reduced. By collecting such sound with reduced high frequency components using the microphone 9a and 9b, processing (for example, correction to frequency characteristics) of the microphone signal S2 can be facilitated. Thus, a degree of freedom in processing a timbre in the timbre synthesizer 11d can be improved.

In the case where the striking head 3 is a fabric woven with multifilaments as described above, attack sound generated when the striking head 3 is struck is likely to be reduced in volume and the sound can be made smooth to the ear. The attack sound is sound that occurs at the moment of striking and has more high frequency components than lingering sound after striking. Accordingly, by providing the striking head 3 made of a fabric and suppressing the attack sound (high frequency components), the degree of freedom in processing the timbre in the timbre synthesizer 11d can further be improved.

In this way, compared to the sound generated when an acoustic drum is struck, in the sound whose volume is reduced by provision of the sound absorbing material 7 or the striking head 3 made of a fabric, high frequency components are reduced. Accordingly, the timbre synthesizer 11d is configured to amplify the components of a predetermined frequency (1 kHz) or higher in the microphone signal S2 of the microphones 9a and 9b, and then mix the microphone signal S2 with the waveform data read from the CPU 11b. Accordingly, the timbre of acoustic drums can be reproduced using the musical tone processed by the timbre synthesizer 11d.

As described above, since a space where the microphone 9a is arranged and a space where the microphone 9b is arranged are partitioned from each other by the sound absorbing material 7, the sound generated when the striking head 3 is struck and the resonance sound of the resonance head 4 are less likely to interfere with each other. Accordingly, the sound generated from the striking head 3 or the resonance head 4 can be collected by the microphones 9a and 9b with reduced noise. Since the microphone signal S2 with reduced noise is output to the timbre synthesizer 11d, the timbre of acoustic drums can be reproduced by the musical tone processed by the timbre synthesizer 11d.

In the present embodiment, the microphones 9a and 9b are provided to separately collect the sound from the striking head 3 and the sound from the resonance head 4. It is particularly effective to provide the microphone 9b on the resonance head 4 side in a case where the percussion instrument 1 simulates a snare drum, that is, a case where a snare wire (not illustrated) is attached to the resonance head 4. By the microphone 9b collecting the sound of the resonance head 4 to which the snare wire is attached, the sound of the snare wire and the sound of the striking head 3 can be separately collected. Accordingly, for example, the volume of the snare wire and the volume of the striking head 3 can be independently adjusted.

Here, a method for determining a striking position in the striking head 3 based on a detection result of the striking sensor 8 may adopt a known configuration, and a detailed description will thus be omitted. Examples of the known configuration include a method for determining a striking position based on a length of a first half wave of a vibration waveform (for example, Japanese Patent Laid-Open No. H10-020854). Examples of a method for determining the start of striking (presence or absence of striking) on the striking head 3 include a method in which it is determined that striking has started when, for example, a vibration of a predetermined magnitude or more is detected by the striking sensor 8.

It is also possible to determine these striking information based on, for example, the sound collected by the microphones 9a and 9b, that is, the microphone signal S2. However, the determination device 11a of the present embodiment is configured to determine the striking information based on the striking signal S1 output from the striking sensor 8, without using the microphone signal S2 output from the microphones 9a and 9b. That is, instead of the vibration propagated from the striking head 3, the vibration of the striking head 3 is directly detected by the striking sensor 8, and the striking information is determined based on the detection result thereof. Accordingly, compared to the case of determining the struck information based on the microphone signal S2 of the microphones 9a and 9b as described above, the struck information can be determined with high accuracy.

As mentioned above, in the percussion instrument 1 of the present embodiment, by using the sound absorbing material 7, providing the striking head 3 (resonance head 4) made of a fabric and bringing the cushion 82 (vibration-proof material) of the striking sensor 8 into contact with the striking head 3, the volume of the percussion instrument 1 is reduced. The volume of the percussion instrument 1 can be reduced by 70% (10 dB) compared to the sound generated when an acoustic drum (head made of a film) is struck. Accordingly, the problems associated with the acoustic drum, such as the possibility of damage caused to the ear, the need to consider the volume balance with other instruments in an ensemble, and the occurrence of restrictions on performance location or time, can be solved.

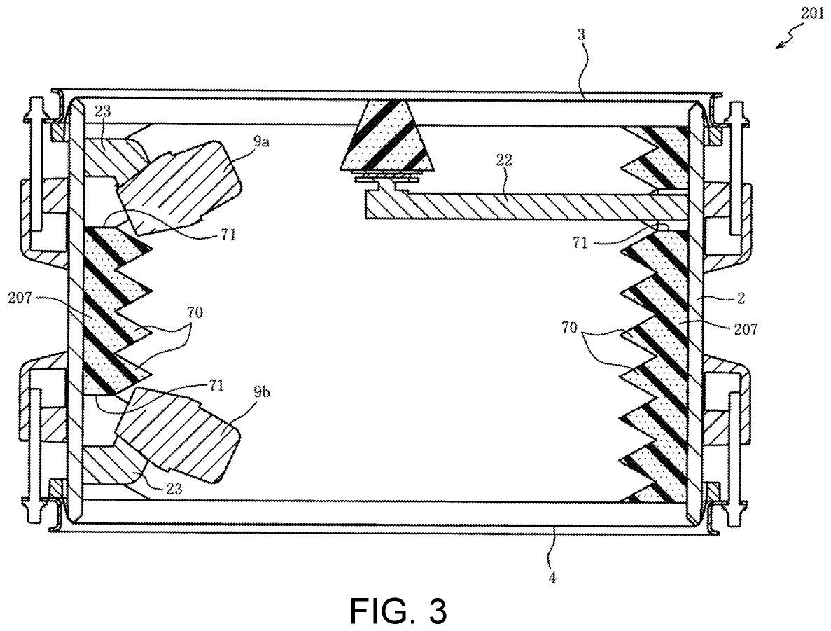

Next, a percussion instrument 201 of the second embodiment is described with reference to FIG. 3. In the first embodiment, a case has been described where the outer edge of the disk-shaped sound absorbing material 7 is joined to the inner peripheral surface of the body 2. In the second embodiment, a case is described where an outer peripheral surface of a sound absorbing material 207 of a cylindrical shape is joined to the inner peripheral surface of the body 2. The same portions as those in the first embodiment are denoted by the same reference numerals and descriptions thereof are omitted. FIG. 3 is a cross-sectional view of the percussion instrument 201 according to the second embodiment. In FIG. 3, in order to simplify the drawing, a plurality of protrusions 70 of the sound absorbing material 207 are illustrated with some of them omitted.

As shown in FIG. 3, the sound absorbing material 207 of the percussion instrument 201 of the second embodiment is obtained by forming the sound absorbing material 7 of the first embodiment into a cylindrical shape. The protrusions 70 are formed without a gap therebetween on an inner peripheral surface of the sound absorbing material 207. The sound absorbing material 207 has a through hole 71 formed in a position where the supports 22 and 23 and the microphones 9a and 9b pass through, and the sound absorbing material 207 is formed in a cylindrical shape continuous in the circumferential direction except for an area where the through hole 71 is formed.

Since the outer peripheral surface of the cylindrical sound absorbing material 207 is joined to the inner peripheral surface of the body 2, the vibration (striking sound) propagated downward when the striking head 3 is struck partially enters the sound absorbing material 207 that is porous, and the vibration is dampened. On the other hand, since the vibration propagated downward from the striking head 3 partially passes through an inner peripheral side of the cylindrical sound absorbing material 207 and is directly transmitted to the resonance head 4, the resonance head 4 can be caused to resonate. In this way, by absorbing the sound generated when the striking head 3 is struck by the sound absorbing material 207 and causing the resonance head 4 to resonate, the timbre of acoustic drums can be reproduced while the volume of the percussion instrument 201 is reduced.

The percussion instrument 201 of the present embodiment includes the same signal processing part 11 (see FIG. 2) as that of the first embodiment. Since the sound whose volume is reduced by the sound absorbing material 207 has reduced high frequency components, by collecting such sound with reduced high frequency components by the microphones 9a and 9b, the processing (for example, correction to frequency characteristics) of the microphone signal S2 can be facilitated.

A thickness of the sound absorbing material 207 in a radial direction (left-right direction in FIG. 3) of the body 2 is one-third or less of a radius of the body 2. A dimension of the sound absorbing material 207 in the axial direction (up-down direction in FIG. 3) is two-thirds or more of the axial dimension (depth) of the body 2. By adjusting the thickness of the sound absorbing material 207 or an axial dimension (distance with the striking head 3 or the resonance head 4) of the sound absorbing material 207 like this, the degree of volume reduction of the sound generated when the striking head 3 is struck or the degree of volume reduction of the resonance sound of the resonance head 4 can be adjusted.

Here, compared to the sound absorbing material 7 (see FIG. 1) of the first embodiment described above, in the case of using the sound absorbing material 207 of the present embodiment, it is difficult to reduce the volume of a sound having a relatively low frequency, and it is easy to reduce the volume of a sound having a relatively high frequency. The reason thereof is described below.

Since the center side of the striking head 3 (resonance head 4) has a larger amplitude during vibration than the outer peripheral side, low frequency vibration (striking sound) is likely to occur. On the other hand, the outer peripheral side of the striking head 3 has a small amplitude during vibration, and high frequency vibration (striking sound) is likely to occur.

In contrast, since the sound absorbing material 207 of the present embodiment is formed in a cylindrical shape covering the inner peripheral surface of the body 2, it is difficult to reduce the volume of low frequency sound compared to the sound absorbing material 7 of the first embodiment that blocks the center side of the body 2. On the other hand, in the sound absorbing material 207 of the present embodiment, since the distance with an outer peripheral portion of the striking head 3 is small, it is easy to reduce the volume of high frequency sound compared to the sound absorbing material 7 of the first embodiment that has a relatively large distance with the outer peripheral portion.

Accordingly, compared to the sound absorbing material 7 of the first embodiment, the sound absorbing material 207 of the second embodiment is capable of reducing the volume while retaining low frequency components. Accordingly, it is preferable to provide the sound absorbing material 207 in a percussion instrument that simulates an acoustic bass drum or tom (which has a deeper depth than a snare drum). Accordingly, the volume of the percussion instrument 201 can be reduced while low frequency components are retained and a timbre typical of a bass drum or tom is maintained.

Since the bass drum or tom has a deep depth (the axial dimension of the body is larger than that of the snare drum), a wide area for arranging the cylindrical sound absorbing material 207 can be secured. Accordingly, by providing the sound absorbing material 207 in the percussion instrument that simulates a bass drum or tom, the volume of the percussion instrument 201 can be effectively reduced while the timbre typical of a bass drum or tom is maintained.

On the other hand, compared to the sound absorbing material 207 of the present embodiment, the sound absorbing material 7 of the first embodiment is capable of reducing the volume while retaining high frequency components. Thus, it is preferable to provide the sound absorbing material 7 in a percussion instrument that simulates a snare drum. Accordingly, the volume of the percussion instrument 1 can be reduced while high frequency components are retained and a timbre typical of a snare drum is maintained.

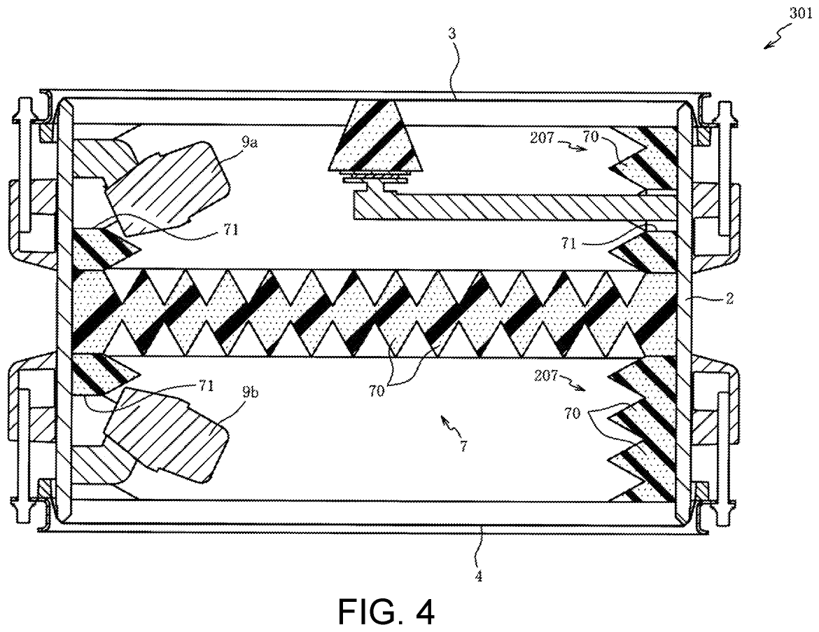

Next, a percussion instrument 301 of a third embodiment is described with reference to FIG. 4. FIG. 4 is a cross-sectional view of the percussion instrument 301 according to the third embodiment.

As shown in FIG. 4, the percussion instrument 301 of the third embodiment is as follows: each of the sound absorbing material 7 of the first embodiment and the sound absorbing material 207 of the second embodiment is provided in the percussion instrument 301. Accordingly, on the sound absorbing material 7, the same protrusions 70 as those in the first embodiment are formed. The sound absorbing material 207 has the same configuration as the sound absorbing material 207 of the second embodiment except that the sound absorbing material 207 is divided into the striking head 3 side and the resonance head 4 side with the sound absorbing material 7 in between. Accordingly, in the sound absorbing material 207, the same protrusions 70 and through holes 71 as those in the second embodiment are formed.

In the percussion instrument 301 configured in this way, the vibration (striking sound) propagated downward when the striking head 3 is struck partially enters the sound absorbing material 207 that is porous, and the vibration is dampened. On the other hand, vibration passing through the inner peripheral side of the cylindrical sound absorbing material 207 enters the sound absorbing material 7 that is porous, and the vibration is dampened. At this time, since the sound absorbing material 7 is brought into a state of being swingable to the body 2, that is, a state in which the sound absorbing material 7 is able to freely vibrate and has no member that hinders the vibration of the sound absorbing material 7 except for a portion in contact with the body 2 or the sound absorbing material 207, the vibration (striking sound) of the striking head 3 causes the sound absorbing material 7 to vibrate as well.

Since moderate vibration is transmitted to the resonance head 4 as well due to the vibration of the sound absorbing material 7, the resonance head 4 is enabled to resonate. In this way, by absorbing the sound generated when the striking head 3 is struck by the sound absorbing materials 7 and 207 and causing the resonance head 4 to resonate, the timbre of acoustic drums can be reproduced while the volume of the percussion instrument 301 is reduced.

The percussion instrument 301 of the present embodiment includes the same signal processing part 11 (see FIG. 2) as that of the first and second embodiments. Since the sound whose volume is reduced by the sound absorbing materials 7 and 207 has reduced high frequency components, by collecting such sound with reduced high frequency components by the microphones 9a and 9b, the processing (for example, correction to frequency characteristics) of the microphone signal S2 can be facilitated.

As mentioned above, while the sound absorbing material 7 is likely to reduce the volume of low frequency sound on the center side of the striking head 3, the sound absorbing material 207 is likely to reduce the volume of high frequency sound on the outer peripheral side of the striking head 3. Accordingly, by attaching each of the sound absorbing materials 7 and 207 to the body 2, it is possible to uniformly reduce the volume in the entire frequency range from low frequencies to high frequencies.

In the present embodiment, the sound absorbing material 7 and the sound absorbing material 207 are arranged so as to contact each other. However, for example, the sound absorbing material 7 and the sound absorbing material 207 may be separated in the up-down direction. Accordingly, since the vibration of the sound absorbing material 7 is less likely to be hindered by the sound absorbing material 207, the resonance head 4 is likely to resonate due to the vibration of the sound absorbing material 7.

Although the present invention has been described above based on the above embodiments, it can be easily inferred that the present invention is not limited to the above embodiments in any way and various improvements or modifications may be made without departing from the spirit of the present invention.

In each of the above embodiments, a case has been described where the striking head 3 and the resonance head 4 are each a fabric woven with multifilaments. However, the present invention is not limited thereto. For example, both or one of the striking head 3 and the resonance head 4 may be formed of other known materials such as a reticulated material (mesh) or a synthetic resin film.

In each of the above embodiments, a case has been described where the sound absorbing materials 7 and 207 are made of urethane foam (foamed resin). However, the present invention is not limited thereto. For example, the sound absorbing materials 7 and 207 may be formed using polyethylene foam, melamine foam, glass wool, or the like. That is, if the resonance head 4 is configured to moderately resonate due to the vibration from the striking head 3, a known sound absorbing material can be used for the sound absorbing materials 7 and 207. In other words, it is sufficient to adjust the thickness or arrangement of the sound absorbing materials 7 and 207 to such an extent that the resonance head 4 resonates according to the material of the sound absorbing materials 7 and 207 (sound absorption performance or ease of vibration).

In each of the above embodiments, a case has been described where the protrusion 70 of a quadrangular pyramid shape is formed on the sound absorbing materials 7 and 207. However, the present invention is not limited thereto. For example, the protrusion 70 may have a shape (for example, wave shape) other than a quadrangular pyramid shape, or the protrusion 70 may be omitted.

In each of the above embodiments, a case where the striking sensor 8 is a contact type sensor and a case where the sensor 81 constituting the striking sensor 8 is a piezoelectric element have been described. However, the present invention is not limited thereto. For example, the striking sensor 8 may use a non-contact type detection element, or may use a contact type detection element such as an electrodynamic type, a capacitance type, or a pressure sensitive resistance type. The striking sensor 8 may be omitted.

In each of the above embodiments, a case has been described where one striking sensor 8 (cushion 82) comes into contact with the center of the striking head 3 in the initial state before striking. However, the present invention is not limited thereto. For example, a plurality of striking sensors 8 (cushions 82) may be brought into contact with the striking head 3, or the striking sensor 8 may be brought into contact with the outer peripheral side rather than the center of the striking head 3. A configuration may be adopted in which the sensor 81 of the striking sensor 8 is omitted and only the cushion 82 is brought into contact with the striking head 3. A configuration may be adopted in which other vibration-proof materials such as rubber, instead of the cushion 82, are brought into contact with the striking head 3, or the vibration-proof material is omitted.

A configuration may be adopted in which, in the case of bringing the vibration-proof material (cushion 82) into contact with the striking head 3, while the vibration-proof material is not in contact with the striking head 3 in, for example, the initial state before striking, the vibration-proof material comes into contact with the striking head 3 due to vibration of the striking head 3 after striking. With this configuration, while the vibration-proof material is brought into contact with the striking head 3 immediately after striking, the vibration-proof material can be separated from the striking head 3 when the vibration of the striking head 3 has weakened. Accordingly, the lingering sound after striking can be retained while the attack sound at the moment when the striking head 3 is struck is suppressed. Accordingly, the timbre of acoustic drums can be reproduced while the volume of the percussion instruments 1, 201 and 301 is reduced.

In each of the above embodiments, a configuration in which the striking information is determined based on the striking signal S1 of the striking sensor 8 and a configuration in which the electronic sound based on the striking signal S1 of the striking sensor 8 and the microphone sound collected by the microphones 9a and 9b are mixed by the timbre synthesizer 11d (signal processing part 11) have been described. However, the present invention is not limited thereto. For example, the striking information may be determined based on the sound collected by the microphones 9a and 9b. It is possible that only the microphone sound collected by the microphones 9a and 9b is processed by the timbre synthesizer 11d without being mixed with the electronic sound based on the striking signal S1 of the striking sensor 8. For example, the timbre synthesizer 11d (signal processing part 11) may be omitted, and the microphone sound collected by the microphones 9a and 9b may be output from the speaker 13 without being processed. One or both of the microphone 9a and the microphone 9b may be omitted.

In each of the above embodiments, a case has been described where the striking sensor 8 is supported by the support 22 and the microphones 9a and 9b are supported by the support 23. However, the present invention is not limited thereto. For example, a configuration may be adopted in which the striking sensor 8 and the microphone 9a are supported in common by the support 22. With this configuration, since the support 23 that supports the microphone 9a can be omitted, the number of parts can be reduced. Furthermore, by omitting the support 23, members that interfere with the vibration (striking sound) propagated from the striking head 3 can be decreased. Thus, the timbre of acoustic drums can be reproduced.

In the first and third embodiments described above, a case has been described where the sound absorbing material 7 is formed in a disk shape. However, for example, a configuration in which the outer edge of the sound absorbing material 7 is partially cut off or a configuration in which a through hole is formed in the sound absorbing material 7 may be adopted. That is, it is sufficient if the sound absorbing material 7 has a substantially disk-like shape as a whole, and is configured to block, for example, 75% or more of the cross-sectional area of the body 2.

Similarly, the sound absorbing material 207 of the second embodiment may have a configuration in which both upper and lower ends of the sound absorbing material 207 are partially cut off or a configuration in which a hole other than the through hole 71 is formed in the sound absorbing material 207. That is, it is sufficient if the sound absorbing material 207 has a substantially cylindrical shape as a whole, and is configured to cover, for example, 75% or more of the inner peripheral surface of the body 2.

### DESCRIPTION OF REFERENCE NUMERALS

1, 201, 301: percussion instrument
2: body
22: support
3: striking head
4: resonance head
7, 207: sound absorbing material
8: striking sensor
81: sensor
82: cushion (vibration-proof material)
9a: microphone (first microphone)
9b: microphone (second microphone)
11: signal processing part
11a: determination device

1. A percussion instrument comprising:
a body of a cylindrical shape;
a striking head, attached to one axial side of the body;
a resonance head, attached to the other axial side of the body; and
a sound absorbing material, formed in a substantially disk shape that provides a partition between the striking head and the resonance head, and having an outer edge joined to an inner peripheral surface of the body.

2. A percussion instrument comprising:
a body of a cylindrical shape;
a striking head, attached to one axial side of the body;
a resonance head, attached to the other axial side of the body; and
a sound absorbing material of a substantially cylindrical shape, having an outer peripheral surface joined to an inner peripheral surface of the body.

3. The percussion instrument according to claim 1, wherein
the striking head is a fabric woven with multifilaments.

4. The percussion instrument according to claim 3, wherein
the resonance head is a fabric woven with multifilaments.

5. The percussion instrument according to claim 3, comprising:
a first microphone, collecting a musical tone generated by vibration of the striking head; and
a signal processing part, amplifying a frequency component of a predetermined frequency or higher of a signal based on the musical tone collected by the first microphone.

6. The percussion instrument according to claim 1, comprising:
a support, extending radially inward from an inner peripheral surface of the body; and
a vibration-proof material, supported by the support in a center of the body, wherein
the vibration-proof material comes into contact with the striking head in response to the striking head being struck.

7. The percussion instrument according to claim 6, wherein
the vibration-proof material is not in contact with the striking head in an initial state before striking.

8. The percussion instrument according to claim 6, wherein
a striking sensor is supported by the support, the striking sensor comprising the vibration-proof material that comes into contact with the striking head in an initial state before striking, and a sensor that is bonded to the other axial side of the vibration-proof material and detects vibration caused by striking on the striking head.

9. The percussion instrument according to claim 8, comprising:
a determination device, determining striking information on the striking head;
a first microphone, collecting a musical tone generated by vibration of the striking head; and
a signal processing part, processing a signal based on the musical tone collected by the first microphone, wherein
the determination device determines the striking information from a signal based on the vibration detected by the striking sensor.

10. The percussion instrument according to claim 9, wherein
the first microphone is supported by the support.

11. The percussion instrument according to claim 1, comprising:
a first microphone, collecting a musical tone generated by vibration of the striking head;
a second microphone, collecting a musical tone generated by vibration of the resonance head; and
a signal processing part, processing a signal based on the musical tones collected by the first microphone and the second microphone.

12. The percussion instrument according to claim 11, comprising:
a sound absorbing material, formed in a substantially disk shape that provides a partition between the striking head and the resonance head, and having an outer edge joined to the inner peripheral surface of the body;
the first microphone, provided between the sound absorbing material and the striking head; and
the second microphone, provided between the sound absorbing material and the resonance head.

13. A method for reducing volume of a percussion instrument, the percussion instrument comprising a body of a cylindrical shape, a striking head attached to one axial side of the body, a resonance head attached to the other axial side of the body, and a sound absorbing material formed in a substantially disk shape that provides a partition between the striking head and the resonance head and having an outer edge joined to an inner peripheral surface of the body, wherein the method comprises:
absorbing, by the sound absorbing material, sound generated when the striking head is struck.

14. A method for reducing volume of a percussion instrument, the percussion instrument comprising a body of a cylindrical shape, a striking head attached to one axial side of the body, a resonance head attached to the other axial side of the body, and a sound absorbing material of a substantially cylindrical shape having an outer peripheral surface joined to an inner peripheral surface of the body, wherein the method comprises:
absorbing, by the sound absorbing material, sound generated when the striking head is struck.

15. The percussion instrument according to claim 2, wherein
the striking head is a fabric woven with multifilaments.

16. The percussion instrument according to claim 15, wherein
the resonance head is a fabric woven with multifilaments.

17. The percussion instrument according to claim 4, comprising:
a first microphone, collecting a musical tone generated by vibration of the striking head; and
a signal processing part, amplifying a frequency component of a predetermined frequency or higher of a signal based on the musical tone collected by the first microphone.

18. The percussion instrument according to claim 15, comprising:
a first microphone, collecting a musical tone generated by vibration of the striking head; and
a signal processing part, amplifying a frequency component of a predetermined frequency or higher of a signal based on the musical tone collected by the first microphone.

19. The percussion instrument according to claim 16, comprising:
a first microphone, collecting a musical tone generated by vibration of the striking head; and
a signal processing part, amplifying a frequency component of a predetermined frequency or higher of a signal based on the musical tone collected by the first microphone.
